(19) United States
(12) Patent Application Publication
(10) Pub. No.: US 2007/0255804 A1
(43) Pub. Date: Nov. 1, 2007

(54) Method of meeting others via the world wide web

(76) Inventor: Keith Cangiarella, Fullerton, CA (US)

Correspondence Address: Keith Cangiarella, 331 N. Harrington Dr, Fullerton, CA, 92831, US

(21) Appl. No.: 11/743,035

(22) Filed: May 1, 2007

Related U.S. Application Data
(60) Provisional application No. 60/796,458, filed on May 1, 2006.

(51) Int. Cl. G06F 15/16

(52) U.S. Cl. 709/217

(57) ABSTRACT

A method of meeting others for friendship, group interests, companionship, or relationship, through the use of illustrations of ones, interests, and/or, personality, and/or likes or dislikes, and/or, personification of oneself. The individual wishing to meet another individual or group of individuals will create an illustration which will personify one self, or what one is seeking, then insert a message telling the viewing party a bit about themselves and what they are looking for.

### CROSS REFERENCES TO RELATED APPLICATIONS

This application claims priority from U.S. Provisional Application No. 60/796,458 filed May 1, 2006, which is incorporated herein by reference for all purposes.

### BACKGROUND—FIELD OF INVENTION

The present invention relates generally to the field of online relationships. The objective of this invention is to provide a method for meeting others via the internet utilizing an illustration that personifies oneself, and a message attached to the illustration advises others about you and what type of relationship you are looking for.

### BACKGROUND—DESCRIPTION OF PRIOR ART

Currently there are numerous companies online that allow people to meet online, match.com, myspace.com, true.com, datemypet.com, and many others.

### All of these sites utilize images of the actual person, or the person and their pet, none of these sites utilize a method of meeting based on illustrations that personifies personality or/and likes or dislikes.

They are basically smorgasbords of images of people in your area based on zip code and miles away from that zip code. Every feeling is based purely on physical attraction rather than personability and/or dislikes or likes. With the exception of charmony.com, this site makes their user take a personality profile exam, and then matches those individuals with other like individuals for the purpose of meeting and building a lasting relationship, which leads to marriage hopefully.

By utilizing an illustration that personifies a persons personality, hobbies, likes or/and dislikes, relationships can be built more on who you are rather than what you look like.

Another objective of this invention is to offer people a new way to meet online without worrying about who will see them, its private, safe and you are only known when you want to be known.

Another objective of this invention is it allows the user to relieve stress from everyday life.

### SUMMARY

A method of meeting others for friendship, group interests, companionship, or relationship, through the use of illustrations of ones interests, and/or, personality, and/or likes or dislikes, and/or, personification of oneself. The individual wishing to meet another individual or group of individuals will create an illustration which will personify one self, or what one is seeking, then insert a message telling the viewing party a bit about themselves and what they are looking for.

This illustration will then be put into a virtual sea, in which others looking for friendship, companionship or a relationship will be able to view these illustrations and messages. If the viewing party is interested they will in turn send back a similar illustration and message to the person. A series of correspondences will occur until the parties decide to invite the other party into their area.

The area is developed by each person, this area is where they can post anything and everything about themselves, or simply the interests that they have. Images of oneself, images of ones car, dog, whatever the person wishes to share with the invited party, only those invited to these areas can view these areas, no one else will have access to these areas except the person who sets it up, and the people they invite into that area.

### DESCRIPTION—PREFERRED EMBODIMENT

A user of the service will come to the website, have an opportunity to register, or simply have limited access to browse around. If interested the user (individual) will register with the service.

They will begin the process of choosing an illustration that demonstrates their personality and/or lies or dislikes, and/or personifies one self or interests. The user may also choose to design ones own illustration which personifies one self or interests. Next the user (individual) will write a message or may choose a message from the message library, adding to the message customizing it to meet their needs. The illustration and message will be sent into the virtual seas for all those seeking to see it may do so.

The user than creates an area which personifies one self or/and interests, which may contain but is not limited to images of one self, images of ones pets, car, home, city, and other interesting information and images the user wishes to put on his/her area. This island will have areas for the user to access messages sent from other users whom have seen their illustration. This area will have multiple features which will allow correspondence with users whom have been invited to this area only those invited to the user's area will be allowed to view and interact with the user.

This is one of the unique features regarding this method of meeting people, only those invited to your area, will have access to you, no other method of meeting people online does this. This will allow for a much safer method of meeting others online, since the user controls whom contacts them, and it is based on several correspondences prior to allowing that user onto your area.

This method of meeting others online is new and unique, and safer than other methods of meeting others online as described above.

Although this invention has been described in terms of preferred embodiment, other embodiments apparent to those of ordinary skill in the art are also within the scope of this invention.

1. A method of meeting others online, utilizing an illustration to personify oneself, along with a message, then others will view illustration and message, utilize an illustration to personify them with a message and reply back to original sender, users will be able to create areas that further personify them, then invite others to their area to further develop relationships.
